(19) United States
(12) Patent Application Publication
(10) Pub. No.: US 2016/0176261 A1
(43) Pub. Date: Jun. 23, 2016

(54) AUTONOMOUS AIR CONDITIONING SYSTEM WITH CLEAN AIR OPTIMIZATION AND POLLUTION DETECTOR

(71) Applicant: Panasonic Automotive Systems Company of America, Division of Panasonic Corporation of North America, Peachtree City, GA (US)

(72) Inventor: TEJAS KHORANA, MARIETTA, GA (US)

(73) Assignee: Panasonic Automotive Systems Company of America, Division of Panasonic Corporation of North America

(21) Appl. No.: 14/973,294

(22) Filed: Dec. 17, 2015

Related U.S. Application Data
(60) Provisional application No. 62/092,912, filed on Dec. 17, 2014.

(51) Int. Cl. B60H 1/00

(52) U.S. Cl. CPC B60H 1/008; B60H 1/00821

(57) ABSTRACT

A method of operating a heating ventilating and air conditioning system of a motor vehicle includes detecting a level of air pollution outside of the vehicle. Depending on the detected level of air pollution, either outside air is drawn into the vehicle's heating ventilating and air conditioning system for blowing into the passenger compartment, or air that is already in the passenger compartment is recirculated.

### CROSS-REFERENCE TO RELATED APPLICATIONS

This application claims the benefit of U.S. Provisional Application No. 62/092,912, filed on Dec. 17, 2014, which the disclosure of which is hereby incorporated by reference in its entirety for all purposes.

### BACKGROUND OF THE INVENTION

1. Field of the Invention

The present invention relates to a method of operating a heating ventilation and air conditioning (HVAC) system in a motor vehicle, and, more particularly, a method of operating an automotive heating ventilation and air conditioning (HVAC) system in an environment with high levels of air pollution.

2. Description of the Related Art

One problem that presents itself on a daily basis to a driver is that the driver is unaware of how polluted the air is either outside or inside the car during his drive. Thus, the driver is unable to factor in these pollution levels in deciding whether to open the car windows and whether to recirculate cabin air or cause outside air to enter the cabin via the HVAC system. If the driver unknowingly allows polluted air into the car from outside the car, that pollution will continuously circulate in the passenger compartment of the car. This high level of air pollution may cause deleterious health consequences to the driver after enough exposure.

### SUMMARY OF THE INVENTION

The invention may provide an automotive HVAC system that addresses the above problems by informing the user of the levels of air pollution both inside and outside the vehicle, and enabling the user to choose between recirculating the cabin air or bringing in outside air.

The invention may provide the driver with information related to how polluted the air is inside and/or outside the vehicle so he can decide Whether to manually aerate the ear by opening the window. This information may also help the driver to decide, when running the HVAC system, whether to allow air to recirculate in the passenger compartment or to introduce outside air into the passenger compartment. In addition to providing the driver with information he or she may use to make decisions about the sources of aeration, the HVAC system can enable the car to make aeration decisions autonomously as well. That is, the HVAC system may automatically switch to recirculation mode or to outside air mode in response to the inside and/outside air pollution measurements. Thus, the driver may simply turn on the air conditioning and automatically get the cleanest possible air in his car instead of risking the possibility of having polluted air circulating inside the car.

In one embodiment, the invention maximizes the amount of fresh air that can enter the car while keeping the air that enters the car as clean as possible when the AC system is running. The invention may also help the driver let the maximum. amount of fresh air and minimum amount of polluted air in his car.

The invention comprises, in one form thereof, a method of operating a heating ventilating and air conditioning system of a motor vehicle, including detecting a level of air pollution outside of the vehicle. Depending on the detected level of air pollution, either outside air is drawn into the vehicle's heating ventilating and air conditioning system for blowing into the passenger compartment, or air that is already in the passenger compartment is recirculated.

The invention comprises, in another form thereof, a method of operating a heating ventilating and air conditioning system of a motor vehicle, including detecting a level of air pollution outside of the vehicle. A level of air pollution inside the vehicle is detected. Depending on the detected level of outside air pollution, and depending on the detected level of inside air pollution, either outside sir is drawn into the vehicles heating ventilating and air conditioning system for blowing into the passenger compartment, or air that is already in the passenger compartment is recirculated.

The invention comprises, in yet another form thereof, an automotive heating, ventilating and air conditioning system for a vehicle, The system includes a first sensor detecting a level of air pollution outside of the vehicle, and a second sensor detecting a level of air pollution inside the vehicle. An air source switch has a first position in which outside air is introduced into a passenger compartment of the vehicle and a second position in which air already in the passenger compartment is recirculated therein. A display screen is disposed in the passenger compartment. An electronic processor is communicatively coupled to the first sensor, the second sensor, the air source switch, and the display screen. The electronic processor actuates the air source switch between the first position and the second position dependent upon readings from the first sensor and/or readings from the second sensor. The electronic processor presents an image on the display dependent upon the readings from the first sensor and/or the readings from the second sensor,

An advantage of the present invention is that it enables the cleanest air available to enter the passenger compartment.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is block diagram of one embodiment of an HVAC system of the present invention.

FIG. 2 is a flow chart of one embodiment of a method of the present invention for operating a heating ventilating and air conditioning system of a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

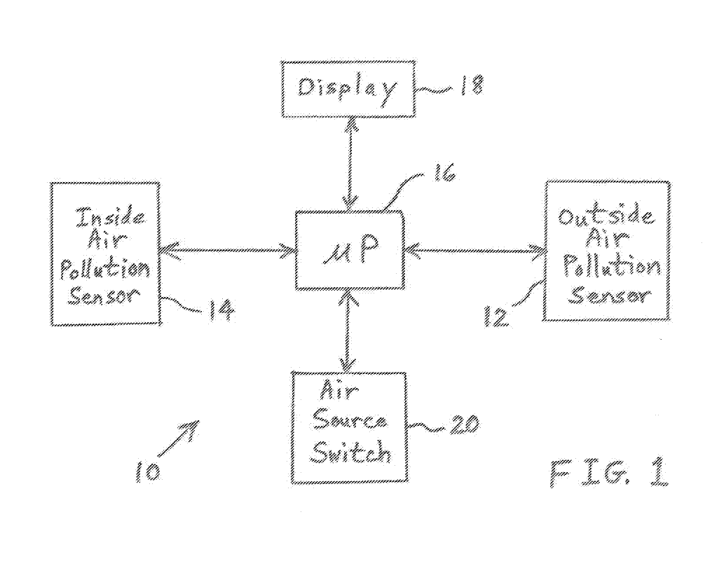

FIG. 1 is a block diagram of one embodiment of an automotive heating, ventilating and air conditioning (HVAC) system 10 of the invention installed in a vehicle and including an outside air pollution sensor 12, an inside air pollution sensor 14, a processor-based controller 16, a display screen 18, and an air source switch 20. Outside air pollution sensor 12 is positioned to sense a level of contaminant particles and/or a level of a pollutant gas, such as carbon monoxide, in the air outside the vehicle, Inside air pollution sensor 14 is positioned to sense a level of contaminant particles and/or a level of a pollutant gas, such as carbon monoxide, within the passenger compartment of the vehicle.

During use, one or both. of air pollution sensors 12, 14 samples the air quality and takes an air pollution reading. The sampling frequency may be approximately between one sample every ten seconds and one sample per second. Regardless of the sampling frequency, the readings may be averaged by processor 16, and processor 16 may respond to this averaged reading rather than to individual sensor readings, which may be transient or quickly changing, For example, a sensor may sense a contaminant particle in one reading and not sense another contaminant particle in hundreds of immediately subsequent readings.

Processor 16 may respond to readings of outside sensor 12 alone (e.g., absolute readings, in which case inside sensor 14 may be omitted from the automotive HVAC system), or may respond to readings of both outside sensor 12 and inside sensor 14 (e.g., relative readings). For example, processor 16 may respond to outside sensor 12 detecting an absolute air pollution level above a default threshold value or above a custom value set by the user, If the detected pollution level is below the default threshold value or the custom value set by the user, then the processor may determine that the outside air is clean. Alternatively, or in addition, processor 16 may respond to the relative difference in air pollution levels detected by outside sensor 12 and inside sensor 14. For example, if the detected pollution level outside the vehicle is below the detected pollution level inside the vehicle, then the processor may determine that the outside air is clean.

Processor 16 may decide whether the air outside of vehicle is clean, and this decision may be based either on only the absolute readings of outside sensor 12 or on the relative difference between the readings of outside sensor 12 and inside sensor 14. Regardless of whether readings from inside sensor 14 are considered by processor 16, if processor 16 determines that the outside air is clean, then processor 16 may actuate air source switch 20 to cause outside air to he drawn into the HVAC system, and ultimately into the passenger compartment, for ventilation, air conditioning and/or heating. In addition, or alternatively, processor 16 may present a text message or other indication on display 18 that the outside air is clean and/or that the vehicle windows can be opened without introducing air pollution. into the passenger compartment. On the other hand, if processor 16 determines that the outside air is not clean (e.g,, the outside air is dirty or polluted), then processor 16 may actuate air source switch 20 to cause inside air to be drawn into the HVAC system, and ultimately recirculated into the passenger compartment, for ventilation, air conditioning and/or heating. In addition, or alternatively, processor 16 may present a text message or other indication on display 18 that the outside air is polluted and/or that the vehicle windows should be closed in order to avoid introducing air pollution into the passenger compartment.

As described above, system 10 may enable the driver to use the air conditioning system, and system 10 may ventilate the car with air outside the car whenever the outside pollution levels are lower than a default or set level on an external pollution detector. Conversely, system 10 may prevent air from entering the car (e.g., may recirculate the air that is already in the passenger compartment) when the air outside has a pollution level that is higher than the custom or default level. The pollution detector (or multiple pollution detectors to improve accuracy of measurement) may he placed or located so that the detector can most accurately detect pollution in the air entering the vehicle through the air conditioning system or windows. Average pollution readings may be continuously taken by the pollution detector. The pollution readings may be displayed in the car on display 18, and this display may be continuously updated. This pollution level information presented to the driver may enable the driver to manually lower the windows when the air pollution level suits his preferences.

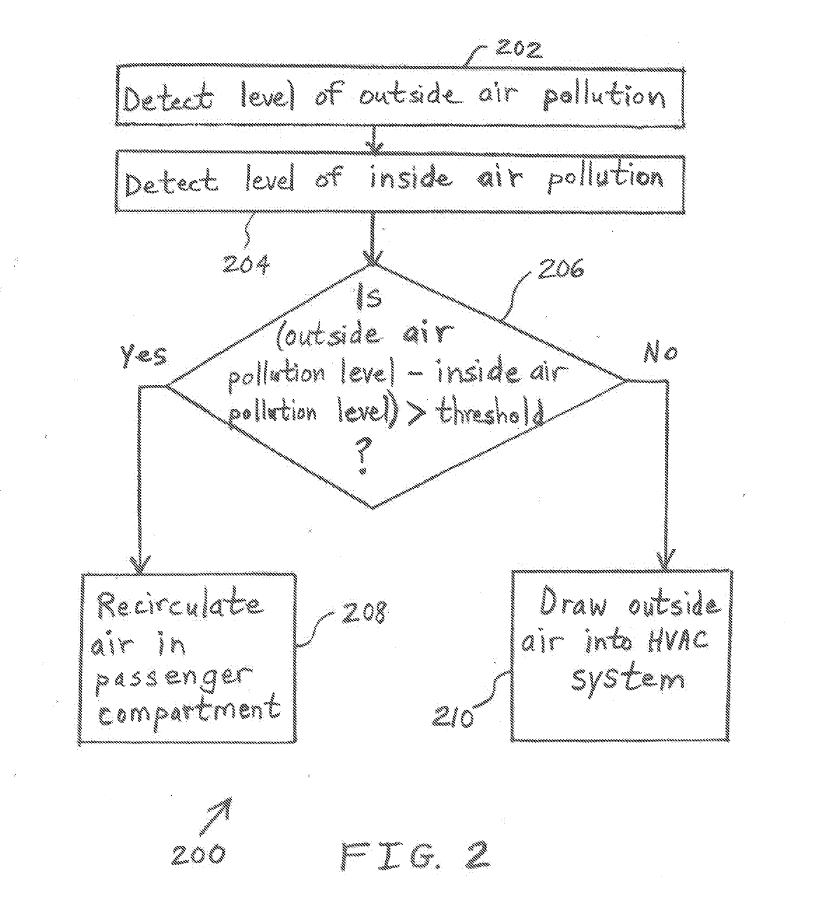

FIG. 2 is a flow chart of one embodiment of a method 200 of the present invention for operating a heating ventilating and air conditioning system of a motor vehicle. In a first step 202, a level of air pollution outside of the vehicle is detected. For example, air-borne contaminant particles and/or a pollutant gas outside the vehicle may be sensed with sensor 12. Next, in step 204, a level of air pollution inside of the vehicle is detected. For example, air-borne contaminant particles and/or a pollutant gas inside the vehicle may be sensed with sensor 14. In step 206, the level of air pollution outside of the vehicle is compared to the level of air pollution inside of the vehicle. For example, processor 16 may subtract the level of air pollution inside of the vehicle from the level of air pollution outside of the vehicle, If this difference exceeds a threshold level, then operation moves to step 208 wherein air inside the passenger compartment is recirculated. On the other hand, if the difference does not exceed a threshold level, then operation moves to step 210 wherein outside air is drawn into the vehicle heating, ventilation and air conditioning system before the outside air is blown into the passenger compartment. Processor 16 may control air source switch 20 based on the determination in step 206. The threshold level may be a fixed, default level, or the threshold level may be a variable level that may he set by a user.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of operating a heating ventilating and air conditioning system of a motor vehicle, the method comprising the steps of:
detecting a level of air pollution outside of the vehicle; and
depending on the detected level of outside air pollution, either:
drawing outside air into the vehicle's heating ventilating and air conditioning system for blowing into the passenger compartment; or
recirculating air that is already in the passenger compartment.

2. The method of claim 1 comprising the further step of actuating an air source switch dependent upon the detected level of outside air pollution.

3. The method of claim 1 comprising the further step of presenting on a display the detected level of outside air pollution.

4. The method of claim 1 comprising the further step of detecting a level of air pollution inside of the vehicle, and the detected level of inside air pollution is a factor in the decision to either:
draw outside air into the vehicle's heating ventilating and air conditioning system for blowing into the passenger compartment; or
recirculate air that is already in the passenger compartment.

5. The method of claim 1 wherein the air pollution outside of the vehicle comprises air-borne contaminant particles and/or a pollutant gas.

6. The method of claim 1 wherein the detecting step is performed by a sensor, and an electronic processor makes the decision to either:
draw outside air into the vehicles heating ventilating and air conditioning system for blowing into the passenger compartment; or
recirculate air that is already in the passenger compartment.

7. The method of claim 6 wherein the electronic processor actuates an air source switch based on the decision.

8. The method of claim 1 wherein the detecting step is performed with a sampling frequency approximately between one sample every ten seconds and one sample per second.

9. The method of claim 8 wherein depending on an average of the detected levels of outside air pollution the decision is made to either:
draw outside air into the vehicle's heating ventilating and air conditioning system for blowing into the passenger compartment; or
recirculate air that is already in the passenger compartment.

10. The method of claim 1 wherein the decision to either draw outside air into the vehicle or recirculate air already inside the vehicle is dependent upon whether the detected level of air pollution outside of the vehicle is above a default threshold air pollution value.

11. The method of claim 1 wherein the decision to either draw outside air into the vehicle or recirculate air already inside the vehicle is dependent upon whether the detected level of air pollution outside of the vehicle is above a custom threshold air pollution value set by the user.

12. A method of operating a heating ventilating and air conditioning system of a motor vehicle, the method comprising the steps of:
detecting a level of air pollution outside of the vehicle;
detecting a level of air pollution inside the vehicle; and
depending on the detected level of outside air pollution, and depending on the detected level of inside air pollution, either:
drawing outside air into the vehicle's heating ventilating and air conditioning system for blowing into the passenger compartment; or
recirculating air that is already in the passenger compartment.

13. The method of claim 12 comprising the further step of actuating an air source switch dependent upon the detected level of outside air pollution and upon the detected level of inside air pollution.

14. The method of claim 12 comprising the further step of presenting on a display an indication of a difference between the detected level of outside air pollution and the detected level of inside air pollution.

15. The method of claim 12 wherein the detecting steps are performed by two respective sensors. and an electronic processor makes the decision to either:
draw outside air into the vehicle's heating ventilating and air conditioning system for blowing into the passenger compartment; or
recirculate air that is already in the passenger compartment.

16. The method of claim 15 wherein depending on an average of the detected levels of outside air pollution, and on an average of the detected levels of inside air pollution, the decision is made to either:
draw outside air into the vehicles heating ventilating and air conditioning system for blowing into the passenger compartment; or
recirculate air that is already in the passenger compartment.

17. The method of claim 12 wherein the decision to either draw outside air into the vehicle or recirculate air already inside the vehicle is dependent upon a difference between the detected level of outside air pollution and the detected level of inside air pollution.

18. The method of claim 17 wherein the decision to either draw outside air into the vehicle or recirculate air already inside the vehicle is dependent upon whether the difference between the detected level of air pollution outside of the vehicle and the detected level of air pollution inside the vehicle is above a default threshold air pollution difference value.

19. The method of claim 17 wherein the decision to either draw outside air into the vehicle or recirculate air already inside the vehicle is dependent upon whether the difference between the detected level of air pollution outside of the vehicle and the detected level of air pollution inside the vehicle is above a custom threshold air pollution difference value set by the user.

20. An automotive heating, ventilating and air conditioning system for a vehicle, the system comprising:
a first sensor configured to detect a level of air pollution outside of the vehicle;
a second sensor configured to detect a level of air pollution inside the vehicle;
an air source switch having a first position in which outside air is introduced into a passenger compartment of the vehicle and a second position in which air already in the passenger compartment is recirculated therein;
a display screen disposed in the passenger compartment; and
an electronic processor communicatively coupled to the first sensor, the second sensor, the air source switch, and the display screen, the electronic processor being configured to:
actuate the air source switch between the first position and the second position dependent upon readings from the first sensor and/or readings from the second sensor; and
present an image on the display dependent upon the readings from the first sensor and/or the readings from the second sensor.
